(19) United States
(12) Patent Application Publication
(10) Pub. No.: US 2011/0121125 A1
(43) Pub. Date: May 26, 2011

(54) Roll Fencing Unfurling and Stretching Apparatus

(75) Inventors: Tom Stow, Vevay, IN (US); Chad Tyler, Dillsboro, IN (US)

(73) Assignee: E-Z STRETCHER LLC, Dillsboro, IN (US)

(21) Appl. No.: 12/779,933

(22) Filed: May 13, 2010

Related U.S. Application Data
(60) Provisional application No. 61/225,561, filed on Jul. 15, 2009.

(51) Int. Cl. E04H 17/26; B65H 16/02; B66D 3/00; B66D 1/26

(52) U.S. Cl. 242/557; 254/214

(57) ABSTRACT

The apparatus for unfurling and stretching roll fencing includes a frame, a fencing roll support, a spindle coupling the frame and roll support, and fencing tensioning devices. In one embodiment, the frame is coupled to skid loader lift arms, a bar is slid through a roll of fencing and is coupled to the roll support, the fencing roll is elevated by the lift arms and rotated vertically, the fencing secured to a first fence post, and the skid loader backed along a line of fence posts to a second fence post, unfurling the fencing, two winches having cables coupled to an upper and a lower portion of the fencing near the second fence post are individually controlled, as required, to vertically position and stretch the unfurled fencing along the line of fence posts, and the fencing is then secured to the second fence post and the intervening posts.

### CROSS-REFERENCE TO RELATED APPLICATIONS

This application claims the benefit of U.S. Provisional Patent Application 61/225,561, filed Jul. 15, 2009, and titled Roll Fencing Unfurling and Stretching Apparatus, which is currently pending and is herein incorporated by reference.

### BACKGROUND

The present invention relates tools for installing fencing, and particularly, an apparatus for unfurling and stretching roll-type fencing.

### SUMMARY

The present invention may comprise one or more of the features recited in the attached claims, and/or one or more of the following features and combinations thereof.

Roll-type fencing includes any type of wire or non-wire fencing that forms a linear sheet or mesh that is provided for installation in a rolled or other gathered or furled arrangement. For example, such fencing includes, but is not limited to, chain link, woven, welded, perforated, expanded, and screen fencing, whether formed from metal and/or other materials.

In one illustrative embodiment, a fencing apparatus for coupling to a vehicle and unfurling and stretching roll fencing includes a frame adapted to be coupled to the vehicle, a roll support adapted to support a rolled portion of fencing, a spindle rotationally coupling the frame and roll support, and a plurality of tensioning devices coupled to the frame, the plurality of tensioning devices operable to stretch at least a first portion of unfurled fencing at a first tension and a second portion of unfurled fencing at a second tension. For example, the first portion of fencing may be an upper portion of fencing and the second portion of fencing a lower portion of fencing.

In one illustrative employment, the fencing apparatus frame is coupled to the lift arms of a skid loader, a bar is slid through a roll of fencing that is positioned horizontally, the bar is coupled to the roll support, the fencing apparatus including the supported fencing roll is elevated by the lift arms, the roll support and fencing roll is rotated vertically, the fencing is secured at the unfurled end to a first end fence post, and the skid loader is backed along a line of fence posts toward a second end fence post, unfurling the fencing along any intervening posts, a winch cable is coupled to each of an upper and a lower portion of the unfurled fencing, two winches associated with the cables are individually controlled to apply tension, including a differential tension if required, to vertically position and stretch the unfurled fencing along the line of fence posts, and the fencing is then secured to the second end fence post and the intervening posts.

A vehicle as defined herein can be any type of conveyance, for example, but not limited to, a skid loader, a front-end loader, or tractor. Alternatively, the vehicle can be a means of conveyance provided integrally with the fencing apparatus.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying Figs. in which:

FIG. 1 is an illustrative embodiment of the fencing apparatus employed with a skid loader;

FIG. 2A is a front view of the fencing apparatus of FIG. 1;

FIG. 2B is a side view of the fencing apparatus of FIG. 2;

FIGS. 3A-3B are detail views of the roll support of the illustrative fencing apparatus;

FIG. 4 is a rear perspective view illustrating the attachment of the fencing apparatus to the lift arms of a typical skid loader;

FIG. 5 is a front perspective view illustrating the roll support in the fencing roll loading position;

FIG. 6 is a front perspective view illustrating the roll support in the fenced roll unfurling position;

FIG. 7 is a partial perspective view illustrating the spindle providing rotation of the roll support relative to the frame;

FIG. 8 is a front perspective view illustrating the tensioning devices;

FIG. 9 is a perspective view illustrating rotation of a fencing roll to a vertical unfurling position during employment of the illustrative embodiment of FIG. 1.

FIG. 10 is a perspective view illustrating anchoring of a first end of an unfurled section of fencing during employment;

FIG. 11 is a perspective view illustrating unfurling the fencing during employment;

FIG. 12 is a perspective view illustrating tensioning of a upper portion and a lower portion of the unfurled fencing during employment; and

FIG. 13 is a perspective view illustrating positioning and attachment of the tension and unfurled fencing during employment.

### DESCRIPTION OF THE ILLUSTRATIVE EMBODIMENTS

For the purposes of promoting and understanding the principals of the invention, reference will now be made to one or more illustrative embodiments, illustrated in the drawings, and specific language will be used to describe the same.

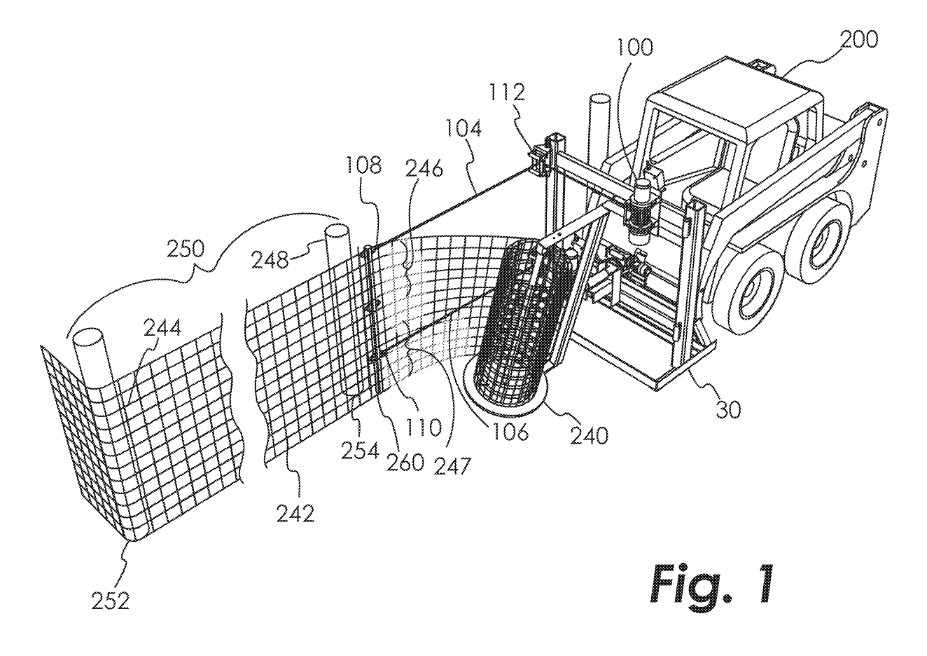

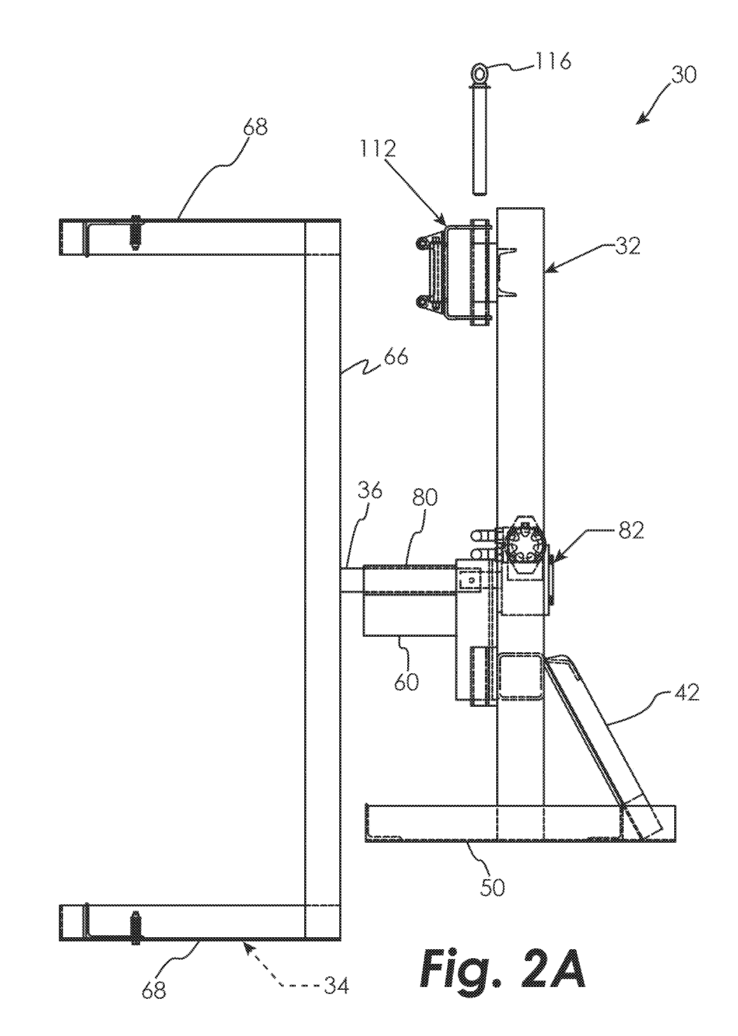

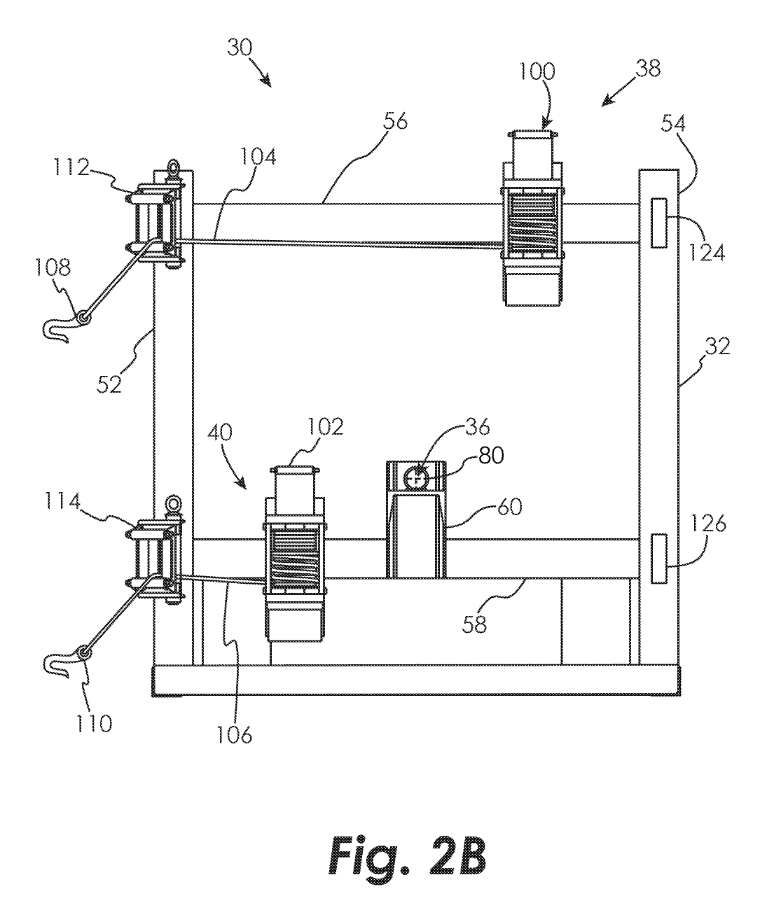

Referring to FIG. 1, the presently disclosed the fencing apparatus 30 can be coupled to a vehicle 200 and is capable of supporting fencing roll 240 for unfurling and stretching unfurled fencing 242, facilitating improved fencing installation and a reduction in the labor required. Referring to FIGS. 2A and 2B, one illustrative embodiment of a fencing apparatus 30 generally includes a frame 32, a fencing roll support 34, a spindle 36, one or more tensioning devices 38, 40, and an attachment 42 for coupling the fencing apparatus 30 to a vehicle, for example a skid loader 200 as shown in FIG. 1.

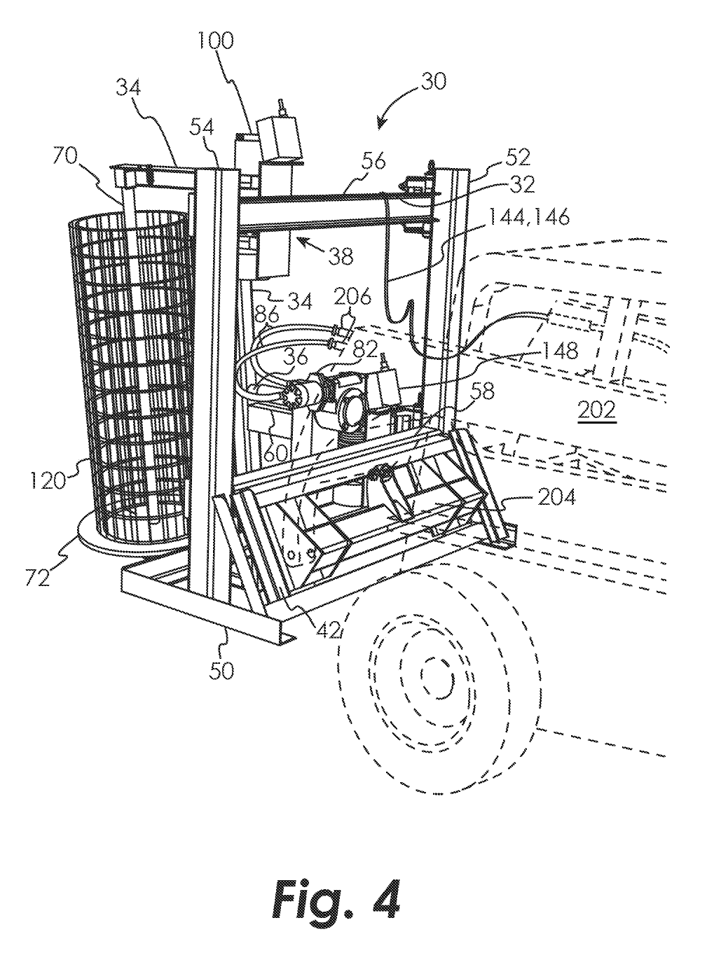

Referring to FIGS. 2A, 2B, and 4, the frame 32 can be constructed from various steel and/or other rigid members, for example, I-beams, angle beams, and/or tubular members. For example, the frame 32 in the illustrative embodiment includes a welded assembly that includes a base 50, a left upright member 52, a right upright member 54, an upper cross member 56, a lower cross member 58, and a spindle support 60. The base 50 supports the assembly 30 in an upright position when resting on a relatively flat surface and detached from the skid loader 200. Advantageously, the attachment 42 can include features and dimensions to provide a universal type receiver for releasable coupling with a standard attachment device 204, for example, such as those typically associated with the lift arms 202 of a skid loader 200, a three point lift hitch on a tractor (not shown), or other such typical components of vehicles.

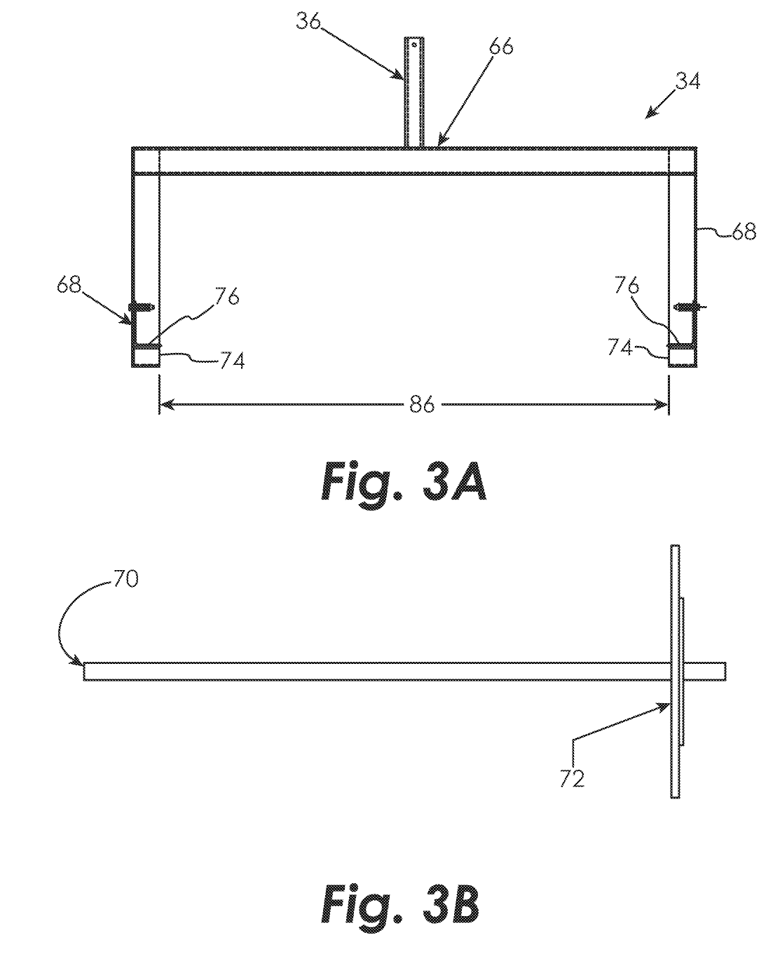

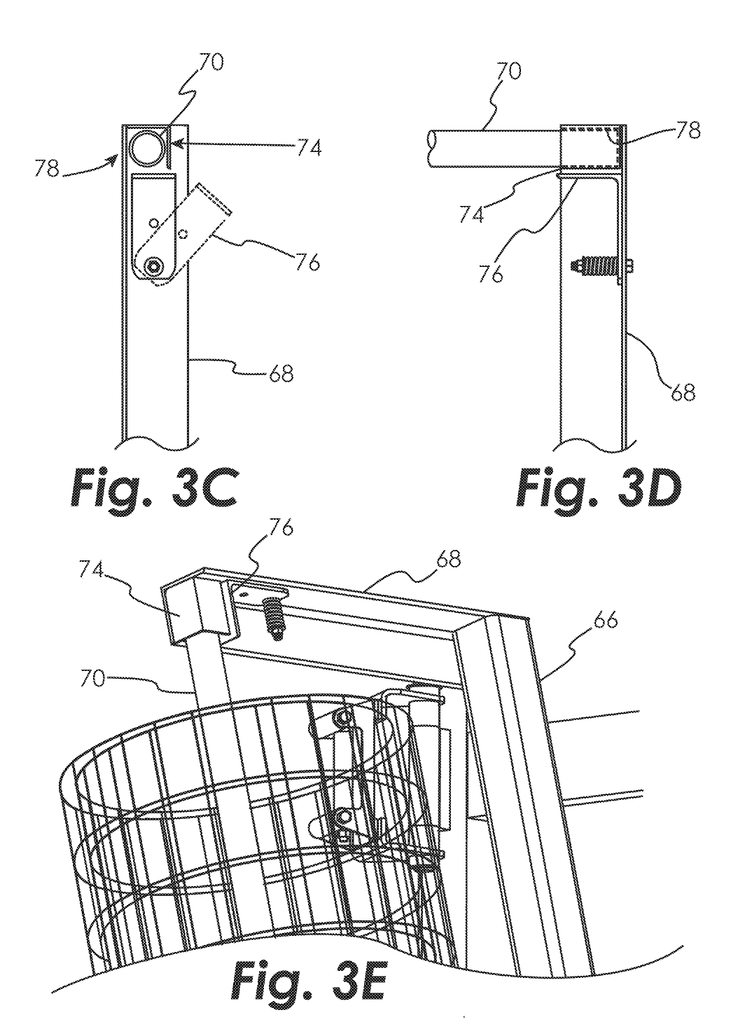

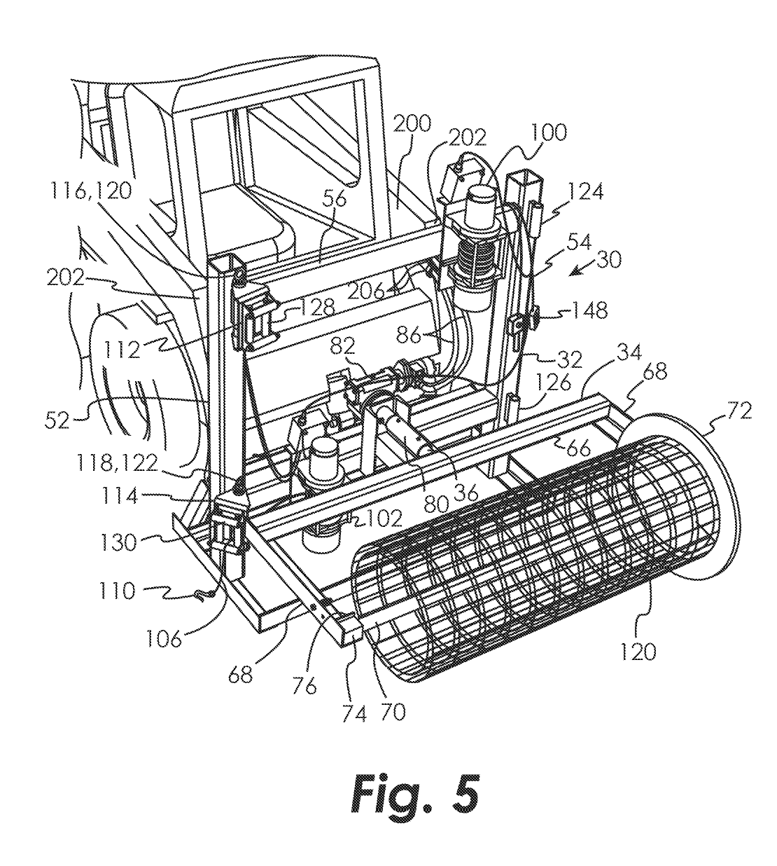

The roll support 34 provides support of the fencing roll 240, including during carriage and unfurling. Referring to the illustrative embodiment in FIG. 3A-3E and FIG. 5, the roll support 34 includes a support cross member 66 of sufficient length to span the desired height of the fencing roll 240, support end members 68, a roll shaft 70, and a roll end guide 72. For example, to support a fencing roll 240 that is 5 foot high, the support cross member 66 should be at least slightly longer than 5 foot so that the end members 68 coupled to each end of the cross member 66 span outside opposite ends of the fencing roll 240. To facilitate keeping the fencing roll 240 aligned and to prevent the fencing roll 240 from catching on the end members 68 during unfurling, a roll guide member having a diameter greater than fencing roll 240 optionally can be positioned at one or both ends between the fencing roll 240 and the end members 68.

In order to mount fencing roll 240, the roll shaft 70 can be detached from the roll support 34, specifically, the roll shaft 70 can be uncoupled from the support end members 68. Referring to FIGS. 3C-3E, the opposite ends of the roll shaft 70 slide into a recess 78 formed by retainer 74 and are held securely in place by a locking member 76. For example, as shown in FIGS. 3C and 3D, a recess 78 fit to receive an end of roll shaft 70 is formed by portions of the structure of the support end member 68, for example angle stock, and the retainer 74, for example angle stock, and the locking member 76 is moveably attached to the support end member 68 so that it can alternately allow the support end member 68 to be slid into the recess 78, or to securely hold the support end member 68 in place within the recess 78 by blocking the exit of the roll shaft 70.

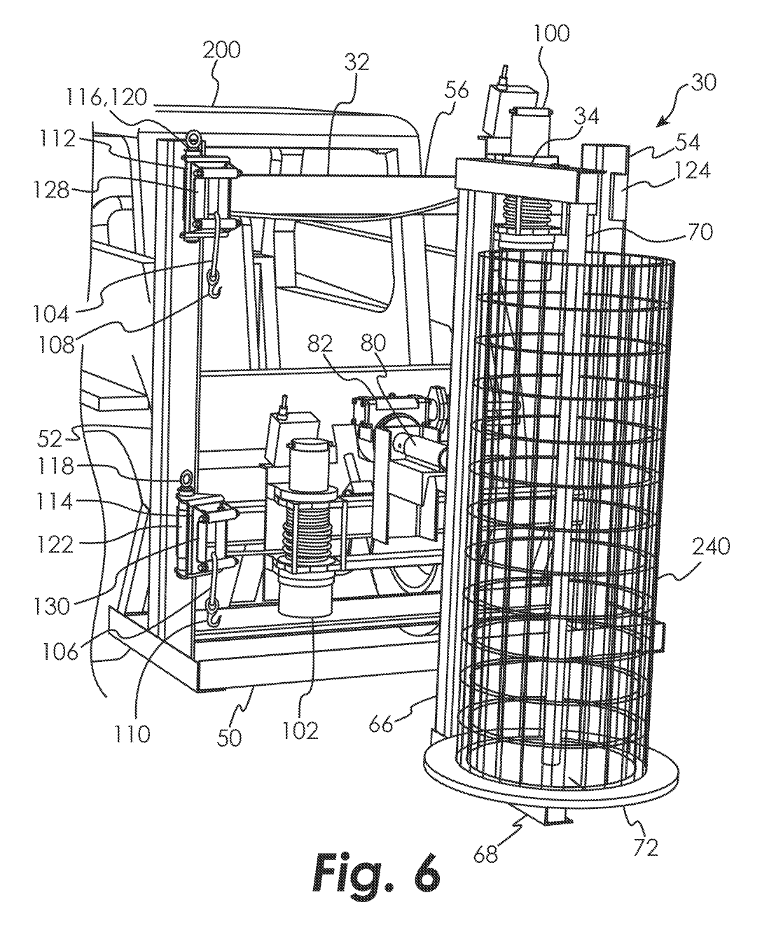

Advantageously, the roll support 34 is rotationally coupled to the frame 32 of the fencing apparatus 30. Specifically, as understood by comparing FIGS. 5 and 6, the rotational connection allows the fencing roll 240 to be positioned horizontally on the ground while roll shaft 70 is inserted through it, the roll shaft 70 is coupled to the roll support 34, then the apparatus 30 is elevated, lifting the fencing roll 240 off the ground, and then the roll support 34 and fencing roll 240 is rotated to a vertical orientation, as shown in FIG. 6.

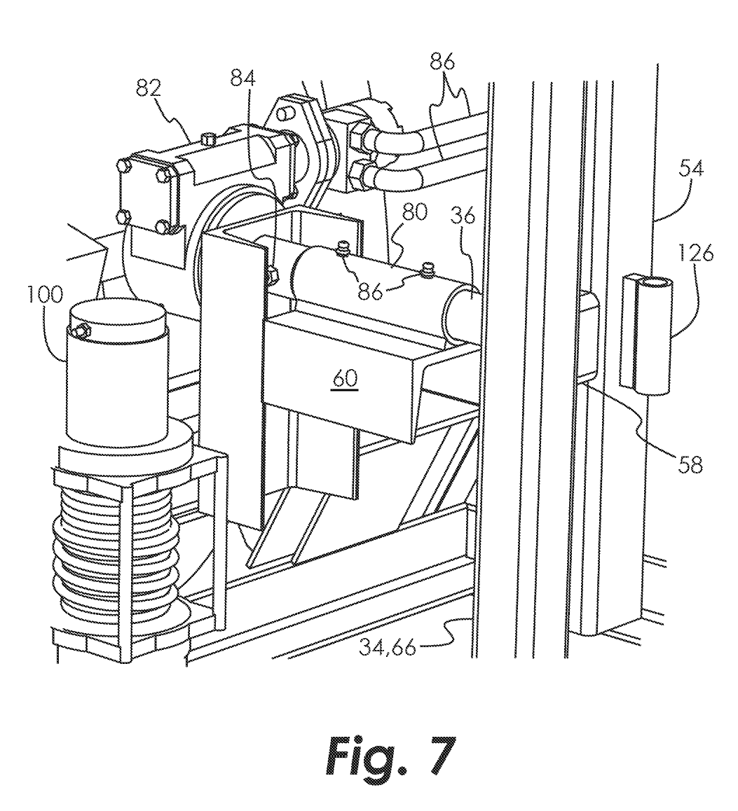

In the illustrative embodiment, the rotational coupling of roll support 34 with the frame 32 is provided by a spindle 36 attached to the roll support 34 and received by a sleeve 80 (FIGS. 2A and 7) functioning as a sleeve bearing for spindle 36. Advantageously, the spindle 36 can be coupled to a rotary motor 82, for example, a hydraulic motor coupled to spindle 36, for example with a fastener 84 (FIG. 7). Advantageously, the hydraulic system or other power source of the vehicle 200 can be utilized for powering and actuating the motor 82, thereby rotating the roll support 34 and fencing roll 240 as desired. For example, hydraulic lines 86 associated with motor 82 can be coupled to hydraulic quick-disconnect couplings 206 of the vehicle 200. The sleeve 86 can also be equipped with grease fittings 86 (FIG. 7) to facilitate lubrication of the interior of sleeve 86 and reduced friction and wear between it and spindle 36.

Advantageously, to facilitate a wider range of fencing types and roll sizes, including the height of the fencing roll 240, a plurality of roll support 34 with varied features can be provided and interchangeable, for example, by simply releasing the spindle 36 and attached roll support 34 by releasing the fastener 84 retaining the spindle 36 to the motor 82. For example, to accommodate a 10 foot high fencing roll 240, an alternative roll support 34 can provide a support cross member 66 having a greater length 86 (FIG. 3A) between the support end members 68, for example, length 86 being slightly longer than the height of the fencing roll 240.

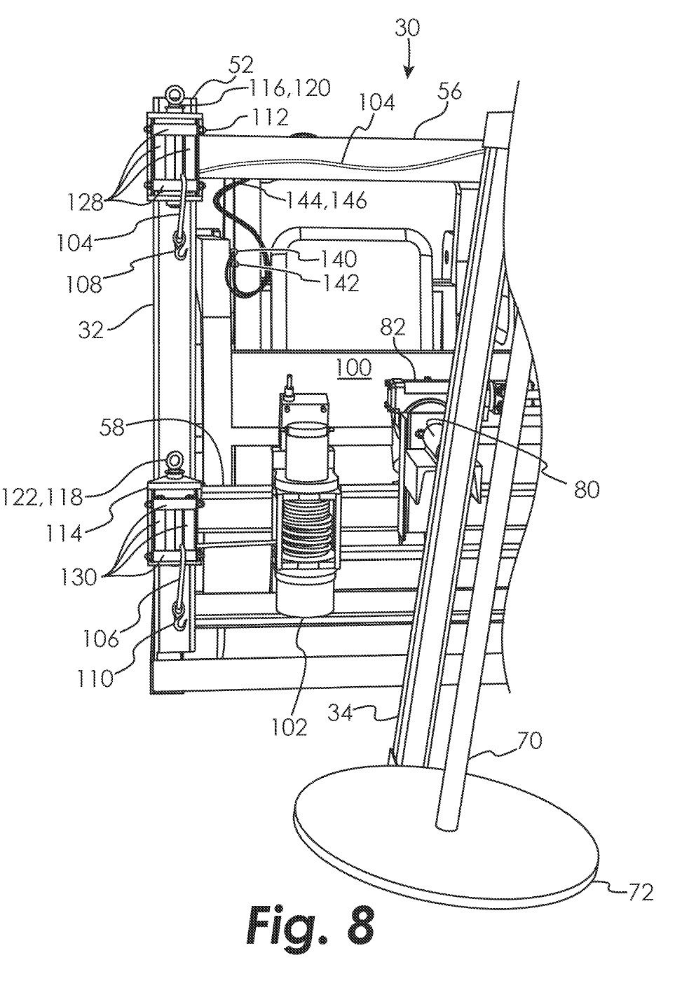

Referring to FIGS. 2B and 8, in the illustrative embodiment, a plurality of tensioning devices 38 and 40 coupled to the frame 32 include an upper and a lower electric cable winch 100 and 102 respectively coupled to the upper cross member 56 and the lower cross member 58. The cable winches 100 and 102 can be used to stretch the fencing 242 taught between or along a series of fences posts. The cable winches 101 and 102 include cables 104 and 106, and releasable fasteners 108 and 110, for example, hooks or clasps. Advantageously, a cable guide 112 and 114 is associated with each cable 104 and 106. The cable guide 112 and 114 provide a means of redirecting the cables 104 and 106 and the tension supplied by them. For example, referring to FIGS. 2B and 8, the cable guide 112 and 114 in the illustrative embodiment are releasably pivotably coupled to two of attachment points 120 and 122 associated with the left upright member 52 and attachment points 124 and 126 associated with the right upright member 54. A retention pin 116 and 118 pivotably secure cable guide 112 and 114, respectively, to the associated attachment points 120-126. Additionally, the cable guide 112 and 114 include rollers 128 and 130 (FIG. 8), respectively. The combination of pivoting and the rollers 128 and 130 allowable the cables 104 and 106 to apply tension throughout a range of approximately 180° relative to the frame 32, namely, upper and lower cross members 56 and 58 upon which the cable winches 100 and 102 are secured, as can be understood from the position of the lower cable guide 114 shown in FIG. 5.

Advantageously, the cable winches 100 and 102 can be powered by power available from the vehicle 200, for example, electrical power supply by electrical outlets 140 and 142 (FIG. 8) associated with the vehicle 200, and received by electrical cables 144 and 146, associated with the fencing apparatus 30. Additionally, the operation of the cable winches can be independently controlled using a remote control 140, enabling, as will be further described below, the stretching of fencing 152 at two different distances from the fencing apparatus 30 and/or at two different tensions.

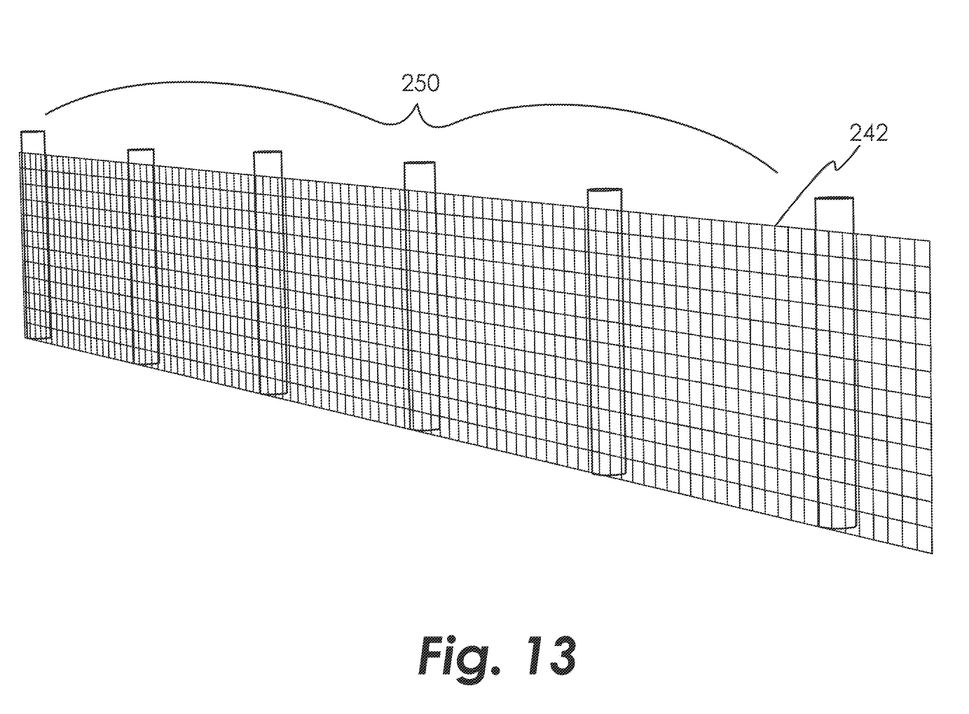

Referring to FIGS. 1, 5, and 9-13, the general steps of employment are shown for an illustrative method of installing fencing 242 from fencing roll 240 using the illustrative embodiment of the fencing apparatus 30 and vehicle 200. First, as is shown in FIG. 2A and further described above, a fencing roll 240 of a desired height is selected, and an roll support member 34 having a length 86 (FIG. 3A) accommodating the fencing height, is coupled, namely rotationally coupling spindle 36 to sleeve 80 and hydraulic motor 82. Next, as is shown in FIG. 5 and further described above, the fencing roll 240 is secured to the roll support 34 for carriage and unfurling.

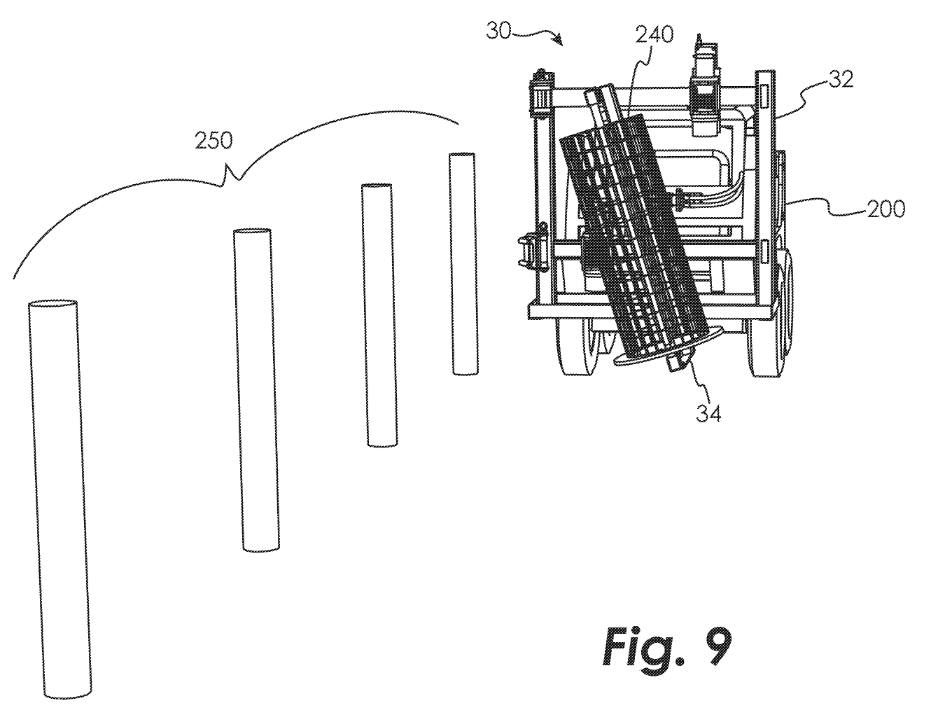

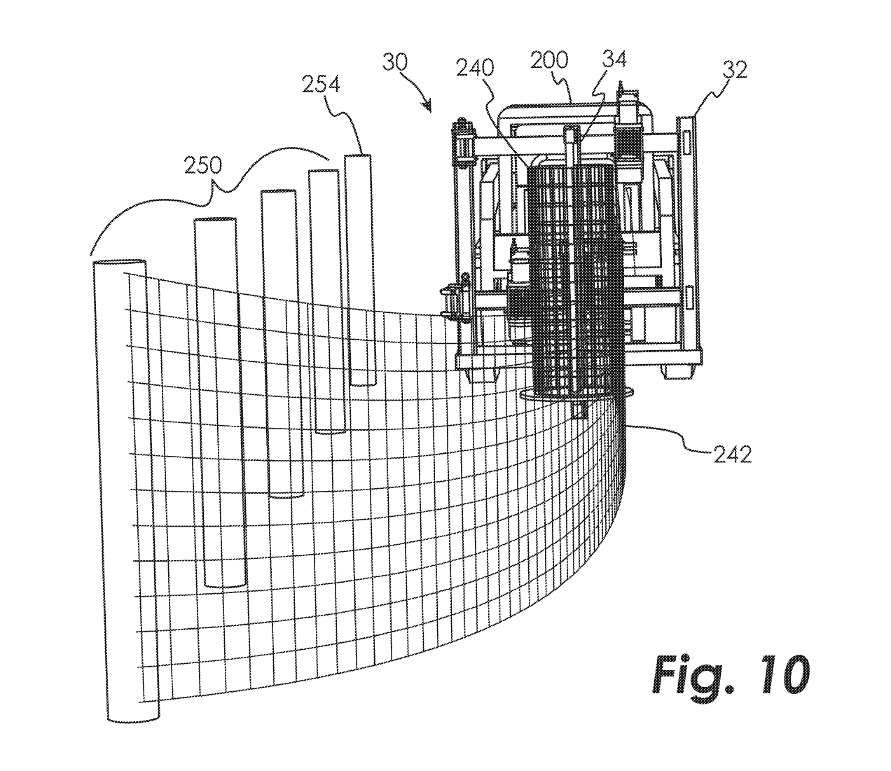

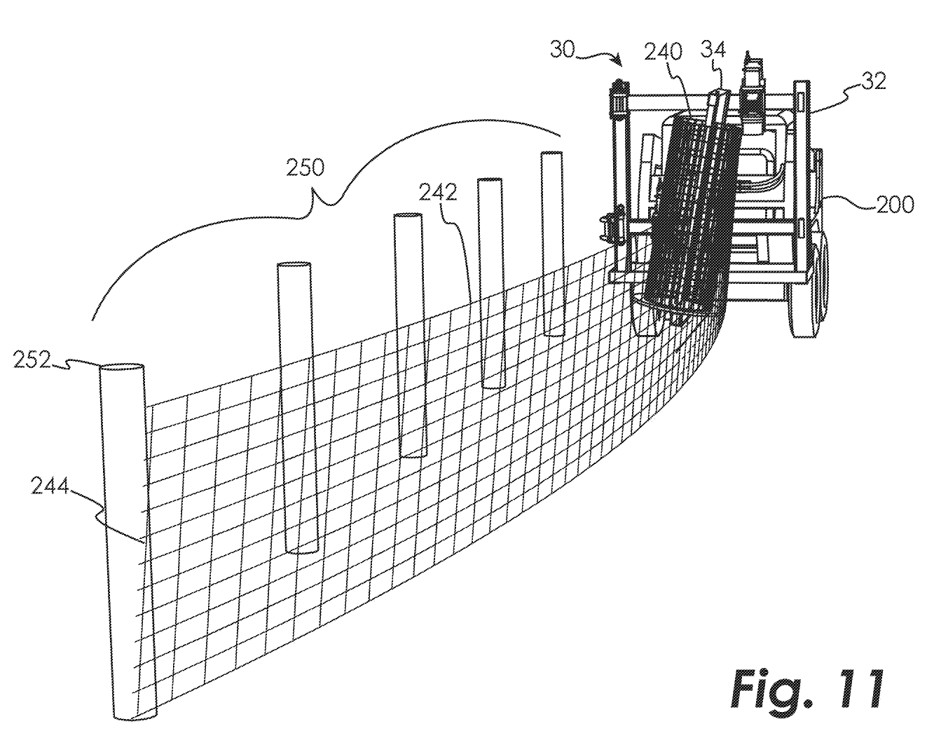

As shown in FIG. 9, the hydraulic motor 82 is engaged to rotate the fencing roll 240 into a vertical upright position for unfurling and installation, and the vehicle 200 is positioned relative to a line of fence posts 250 upon which fencing 242 is to. Referring to FIG. 10, a first end 244 of unfurled fencing 242 is secured to a first fence post 252. Referring to FIG. 11, next, the vehicle 200 is maneuvered to carry the fencing roll 240 along the length of fence posts 250, and toward a second fence post 254, thus further unfurling fencing 242 from fencing roll 240 along the length of fence posts 250. While the fencing 242 could be secured to the fence posts 250 as the fencing 242 is unfurled, in the illustrative employment as much as 2,200 feet of unfurled fencing 242 has been unfurled along fence posts 250, including around bends in fence posts 250 and on varying slopes, and then stretched tight, as described below, before the fencing 240 is secured to the second fence post 254 and intermediate fence posts 250.

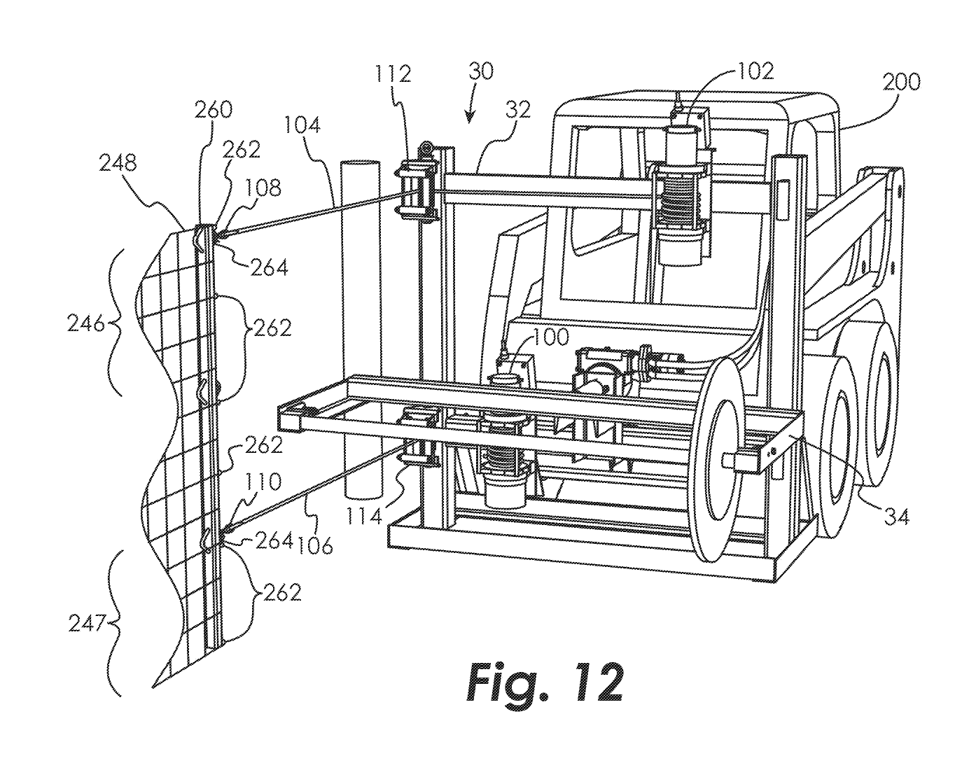

Referring to FIGS. 1 and 12, the tensioning devices 38 and 40 are next used to pull the unfurled fencing 242 taut against the first fence end 244 anchored on first end post 252, while the fencing 242 is being aligned relative to the intermediate fence posts 250, for example, both boy manually positioning the fencing 242 relative to the intermediate fence posts 250, if required, and by applying differential tensions to a first portion 246 and a second portion 247 of a second section or end 248 of the unfurled fencing 242. Also, the roll support 34 can be rotated, if required, to facilitate untwisting the unfurled fencing 242. Also, if required, fencing 242 can be cut to separate the unfurled section of fencing 242 from that remaining on fencing roll 240, if any.

For example, as shown in FIGS. 1 and 12, a fence stretcher 260, generally being an elongate member about the height of the fencing 242, can be used in combination with the tensioning devices 38 and 40 to stretch the fencing 242 taut. For example, fence stretcher 260 includes projections 262 for engaging fencing 242 at fencing section or end 248, and also includes fastening points 264 for attaching fasteners 108 and 110 associated with cables 104 and 106 of cable winches 112 and 114.

With this arrangement, a first portion of fencing 242, for example, an upper portion 246 at section or end 248, for example, an upper quarter or upper third, can be tensioned using upper cable winch 100, and a second portion of fencing 242, for example, a lower portion 247 at section or end 248, for example, a lower half or lower third, can be tensioned using lower cable winch 102. The differential tensions can be used to advantageously accommodate stretch fencing 242 across slopes and to facilitate aligning with and applying even tension along intermediate fence posts 250. Advantageously, the vehicle 200 and fencing apparatus 30 does not need to be fully aligned relative to the fencing 242 and fence posts 250, because the cable guides 112 and 114 are free to pivot relative to frame 32, thus self aligning the cable 104 and 106 and applied tension between the fence section or end 248 and guides 112 and 114. Once the fencing 242 is aligned and stretched as desired, the fencing 242 is secured to the posts 250 and second end post 254. The tensioning devices 28 and 40 and, if utilized, fence stretcher 260 can then be uncoupled from the installed fencing 242.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. An apparatus for coupling to a vehicle and unfurling and stretching roll fencing, comprising:
a frame adapted to be coupled to the vehicle;
a first roll support adapted to support a rolled portion of fencing;
a spindle rotationally coupling the frame and first roll support; and
a plurality of tensioning devices coupled to the frame, the plurality of tensioning devices operable to stretch at least a first portion of unfurled fencing at a first tension and a second portion of unfurled fencing at a second tension.

2. The system of claim 1, wherein the plurality of tensioning devices are independently operable to apply tension to the fencing.

3. The system of claim 1, wherein the plurality of tensioning devices each include a length adjustable tensioning member, the length of each length adjustable tensioning members being independently adjustable.

4. The system of claim 3, wherein the plurality of tension devices include cable winches.

5. The system of claim 4, further comprising a roller guide associated with a cable for each of the cable winches.

6. The system of claim 5, wherein the roller guide is pivotably coupled to the frame.

7. The system of claim 5, wherein the roller guide is releaseably pivotably couplable to a left or right side of the frame.

8. The system of claim 1, further comprising a tensioning bar adapted to couple across at least a portion of the height of the unfurled fencing; and, wherein a first one of the plurality of tensioning devices is coupled to an upper portion of the tensioning bar, and a second one of the plurality of tensioning devices is coupled to a lower portion of the tensioning bar.

9. The system of claim 1, further comprising a hydraulic motor for rotating the spindle and roll support relative to the frame.

10. The system of claim 9, wherein the hydraulic motor is driven by a hydraulic system associated with the vehicle.

11. The system of claim 1, further comprising a second roll support, and wherein the first and second roll supports are interchangeably coupled to the frame, and the first and second roll support each having a different span to accommodate fencing of a different height.

12. An apparatus for coupling to a vehicle and unfurling and stretching roll fencing, comprising:
a frame adapted to be coupled to the vehicle;
a first roll support adapted to support a rolled portion of fencing and coupled to the frame; and
a plurality of tensioning devices coupled to the frame, the plurality of tensioning devices operable to stretch at least a first portion of unfurled fencing at a first tension and a second portion of unfurled fencing at a second tension.

13. The system of claim 12, wherein the plurality of tensioning devices are independently operable to apply tension to the fencing.

14. The system of claim 12, wherein the plurality of tensioning devices each include a length adjustable tensioning member, the length of each length adjustable tensioning members being independently adjustable.

15. The system of claim 14, wherein the plurality of tension devices include cable winches.

16. The system of claim 15, further comprising a roller guide associated with a cable for each of the cable winches.

17. The system of claim 16, wherein the roller guide is pivotably coupled to the frame.

18. The system of claim 16, wherein the roller guide is releaseably pivotably couplable to a left or right side of the frame.

19. The system of claim 12, further comprising a tensioning bar adapted to couple across at least a portion of the height of the unfurled fencing; and, wherein a first one of the plurality of tensioning devices is coupled to an upper portion of the tensioning bar, and a second one of the plurality of tensioning devices is coupled to a lower portion of the tensioning bar.

20. The system of claim 12, further comprising a second roll support, and wherein the first and second roll supports are interchangeably coupled to the frame, and the first and second roll support each having a different span to accommodate fencing of a different height.
